(19) United States
(12) Patent Application Publication
(10) Pub. No.: US 2025/0023069 A1
(43) Pub. Date: Jan. 16, 2025

(54) FUEL CELL SYSTEM

(71) Applicants: Hyundai Motor Company, Seoul (KR); Kia Corporation, Seoul (KR)

(72) Inventor: Oh Tak Kwon, Yongin-si (KR)

(21) Appl. No.: 18/503,849

(22) Filed: Nov. 7, 2023

(30) Foreign Application Priority Data
Jul. 13, 2023 (KR) 10-2023-0090766

(51) Int. Cl. H01M 8/04119; B60L 58/30; H01M 8/04007; H01M 8/04014; H01M 8/04492; H01M 8/04746

(52) U.S. Cl. CPC H01M 8/04164; B60L 58/30; H01M 8/04014; H01M 8/04074; H01M 8/04141; H01M 8/04492; H01M 8/04753; H01M 2250/20

(57) ABSTRACT

In an embodiment, a fuel cell system in which heat exchange between high-temperature and high-humidity exhaust gas discharged from a stack and low-temperature inlet air to be supplied to the stack can be performed by a heat exchanger, whereby water can be easily collected from the exhaust gas and can be recycled. In an embodiment, hot air can be generated from the air to be supplied to the stack using a vortex cooler, and can be supplied to a wet air discharge line through which the high-temperature and high-humidity exhaust gas flows, whereby the exhaust gas moving toward the heat exchanger along the wet air discharge line can be increased in temperature by the hot air generated in the vortex cooler, thus further increasing an amount of water that can be collected from condensed water generated from the exhaust gas.

### CROSS-REFERENCE TO RELATED APPLICATIONS

This application claims the benefit of Korean Patent Application No. 10-2023-0090766, filed on Jul. 13, 2023, which application is hereby incorporated herein by reference.

### TECHNICAL FIELD

The present disclosure relates to a fuel cell system.

### BACKGROUND

As is well known, a fuel cell system for a fuel cell vehicle includes a fuel cell stack, a fuel supply system configured to supply fuel (hydrogen) to the fuel cell stack, an air supply system configured to supply air (oxygen), which is an oxidizer required for an electrochemical reaction, to the fuel cell stack, and a heat/water management system configured to control the operating temperature of the fuel cell stack.

In order to generate electrical energy through an electrochemical reaction of the fuel cell stack (hereinafter referred to as a stack), hydrogen is supplied from the fuel supply system to a fuel electrode (anode) of the stack, and air is supplied to an air electrode (cathode) of the stack.

Therefore, an oxidation reaction of hydrogen for generating hydrogen ions (protons) and electrons occurs in the fuel electrode of the stack. The generated hydrogen ions and electrons pass through an electrolyte membrane and a separator of the stack, respectively, and move to the air electrode. In the air electrode, water is generated through an electrochemical reaction between the hydrogen ions and electrons from the fuel electrode and oxygen contained in the air, and electrical energy is generated due to flow of the electrons.

Hereinafter, the configuration and operation of an air supply system of a conventional fuel cell system will be described.

FIG. 1 is a configuration diagram showing an air supply system and a heat/water management system of a conventional fuel cell system.

In FIG. 1, reference numeral 100 denotes a stack.

An air supply system 200 is connected to an air electrode of the stack 100 in order to supply air to the stack 100.

The air supply system 200 may include an air intake filter 201 configured to remove foreign substances contained in outside air, an air compressor 202 configured to suction and compress outside air and to supply the compressed air to a humidifier 204, and an air intake cooler 203 configured to cool the compressed air before the compressed air enters the humidifier 204, wherein the humidifier 204 humidifies the air from the air intake cooler 203 so that the air has an appropriate humidity, and then supplies the humidified air to the air electrode of the stack 100.

In detail, the air intake filter 201, the air compressor 202, the air intake cooler 203, and the humidifier 204 may be sequentially arranged in an air flow direction in an air supply line 205 connected to the air electrode of the stack 100.

Considering that humidification of an electrolyte membrane included in each of the cells of the stack 100 is essential, the humidifier 204 may be implemented as a membrane humidifier configured to cause exhaust gas (wet gas state containing water and water vapor) generated by the electrochemical reaction in the stack 100 and discharged from the stack 100 and dry air moving from the air compressor 202 toward the stack 100 to exchange moisture with each other.

In this case, the humidification operation of the humidifier 204 includes an operation in which dry air compressed by the air compressor 202 is supplied to the interior of a hollow fiber membrane (not shown) of the humidifier 204, an operation in which exhaust gas (wet gas state containing water and water vapor) discharged from the air electrode of the stack 100 passes through a wet air line 206 and flows along an outer peripheral portion of the hollow fiber membrane in the humidifier 204, and an operation in which only portions of the water and the water vapor contained in the exhaust gas enter the hollow fiber membrane due to a capillary phenomenon and humidify the dry air. The humidified air is supplied to the air electrode of the stack 100 through the air supply line 205.

In addition, during the reaction for generation of electrical energy in the stack 100, when a portion of hydrogen, not used for the reaction, is purged from the stack to a purge line 207, condensed water generated by the electrochemical reaction in the stack and accumulated in the stack is also discharged to the purge line 207. The discharged condensed water is stored in a water trap 208 connected to the purge line 207.

The condensed water stored in the water trap 208 may be supplied to the humidifier 204 to be used for humidification of the dry air. Alternatively, when the amount of water stored in the water trap exceeds a predetermined level, a drain valve 209 may be controlled to be opened to discharge the water to the outside.

When the exhaust gas (wet gas state containing water and water vapor) discharged from the air electrode of the stack 100 passes through the wet air line 206 and flows along the outer peripheral portion of the hollow fiber membrane in the humidifier 204, only portions of the water and the water vapor contained in the exhaust gas enter the hollow fiber membrane due to a capillary phenomenon and humidify the dry air, and the remaining portions of the water and the water vapor contained in the exhaust gas are discharged to the outside along a wet air discharge line 210 connected to the humidifier 204.

In this case, an air pressure regulator 211 configured to regulate discharge pressure of the exhaust gas and a silencer 212 configured to regulate noise of the exhaust gas may be sequentially connected to the wet air discharge line 210.

However, the conventional fuel cell system described above has the following problems.

First, after the exhaust gas (wet gas state containing water and water vapor) is discharged from the stack 100 to the wet air line 206, portions of the water and the water vapor contained in the exhaust gas enter the hollow fiber membrane of the humidifier 204 and humidify dry air. However, the remaining portions of the water and the water vapor contained in the exhaust gas are uselessly discharged out of a fuel cell vehicle along the wet air discharge line 210. That is, significant water loss occurs.

Second, if the remaining portions of the water and the water vapor contained in the exhaust gas are uselessly discharged out of a fuel cell vehicle along the wet air discharge line 210, the discharged water may freeze on roads or parking lots in winter or may splash onto a following vehicle during high-speed travel, which may cause accidents.

Therefore, there is a need to develop technology for collecting as much water as possible from water to be discharged out of a fuel cell vehicle along the wet air discharge line via the humidifier in order to recycle the water.

The above information disclosed in this Background section is only for enhancement of understanding of the background of the disclosure, and therefore it may contain information that does not form the related art that is already publicly known.

### SUMMARY

The present disclosure relates to a fuel cell system. More particularly, it relates to a fuel cell system in which inlet air to be supplied to a fuel cell stack is cooled to a low temperature by a vortex cooler and the low-temperature air exchanges heat with high-temperature exhaust gas discharged from the fuel cell stack, thereby maximizing the amount of water that is collected from the exhaust gas discharged from the fuel cell stack.

The present disclosure has been made in an effort to solve the above-described problems associated with the related art, and an embodiment of the present disclosure can provide a fuel cell system in which heat exchange between high-temperature and high-humidity exhaust gas (wet gas state containing water and water vapor) discharged from a stack and inlet air to be supplied to the stack is performed by a heat exchanger, whereby water may be easily collected from the exhaust gas discharged from the stack and may be recycled.

In addition, an embodiment of the present disclosure can provide a fuel cell system in which air to be supplied to the stack is divided into cold air and hot air by a vortex cooler and in which the generated cold air is supplied to the heat exchanger, and at the same time, the generated hot air is supplied to a wet air discharge line through which the high-temperature and high-humidity exhaust gas flows, whereby the high-temperature and high-humidity exhaust gas moving toward the heat exchanger along the wet air discharge line can be increased in temperature by the high-temperature air generated in the vortex cooler and can exchange heat with the low-temperature cold air in the heat exchanger, thus further maximizing the amount of water that can be collected from condensed water generated from the high-temperature and high-humidity exhaust gas.

In an embodiment of the present disclosure, a fuel cell system includes a stack, an air supply line connected to the stack to supply air to the stack, a wet air discharge line connected to the stack to discharge high-temperature and high-humidity exhaust gas, and a heat exchanger mounted at a preset or selected position so as to be connected to the air supply line and the wet air discharge line and configured to perform heat exchange between low-temperature air flowing along the air supply line and the high-temperature and high-humidity exhaust gas flowing along the wet air discharge line.

In an embodiment, the heat exchanger may be mounted at an intersection point between a part of the air supply line interconnecting an air intake filter and an air compressor, and a part of the wet air discharge line extending from a humidifier and interconnecting an air pressure regulator and a silencer.

In an embodiment, the heat exchanger may include a case including an air supply port and an exhaust gas outlet port formed on one side thereof and an exhaust gas inlet port and an air discharge port formed on the opposite side thereof. A part of the air supply line extending from the air intake filter may be connected to the air supply port, a part of the wet air discharge line extending to the silencer may be connected to the exhaust gas outlet port, a part of the wet air discharge line extending from the humidifier and passing through the air pressure regulator may be connected to the exhaust gas inlet port, and a part of the air supply line extending to the air compressor may be connected to the air discharge port. The heat exchanger may further include a heat exchange member mounted in the case and including a plurality of first heat exchange passages formed to allow air to flow from the air supply port to the air discharge port therethrough and a plurality of second heat exchange passages formed to allow exhaust gas to flow from the exhaust gas inlet port to the exhaust gas outlet port therethrough, and the plurality of first heat exchange passages and the plurality of second heat exchange passages may cross each other.

In an embodiment, the case may further include a drain hole formed in a lower portion thereof to collect condensed water generated from the exhaust gas during heat exchange between the air flowing through the plurality of first heat exchange passages and the exhaust gas flowing through the plurality of second heat exchange passages.

In an embodiment, the fuel cell system may further include a water tank connected to the drain hole in the case to store the condensed water.

In an embodiment, the heat exchanger may include a housing including an air supply port and an exhaust gas outlet port formed on one side thereof and an exhaust gas inlet port and an air discharge port formed on the opposite side thereof. A part of the air supply line extending from the air intake filter may be connected to the air supply port, a part of the wet air discharge line extending to the silencer may be connected to the exhaust gas outlet port, a part of the wet air discharge line extending from the humidifier and passing through the air pressure regulator may be connected to the exhaust gas inlet port, and a part of the air supply line extending to the air compressor may be connected to the air discharge port. The heat exchanger may further include an air flow pipe formed in a zigzag shape and located in the housing so as to be connected between the air supply port and the air discharge port and heat exchange fins attached to the air flow pipe. Exhaust gas introduced into the housing through the exhaust gas inlet port and flowing toward the exhaust gas outlet port may exchange heat with air flowing through the air flow pipe through the heat exchange fins.

In an embodiment, the housing may further include a drain hole formed in a lower portion thereof in order to collect condensed water generated from the exhaust gas by heat exchange.

In an embodiment, the fuel cell system may further include a water tank connected to the drain hole in the housing to store the condensed water.

In an embodiment, the fuel cell system may further include a vortex cooler mounted in a part of the air supply line interconnecting the air intake filter and the heat exchanger.

In an embodiment, the vortex cooler may be configured to divide air to be supplied to the stack from the air intake filter into low-temperature cold air and high-temperature hot air, to supply the low-temperature cold air to the heat exchanger, and to supply the high-temperature hot air to a part of the wet air discharge line located between the humidifier and the air pressure regulator.

In an embodiment, the fuel cell system may further include a first bypass line connected between a high-temperature gas discharge port of the vortex cooler and a part of the wet air discharge line located between the humidifier and the air pressure regulator to allow the high-temperature hot air to flow to the wet air discharge line.

In an embodiment, the fuel cell system may further include a second bypass line connected between a part of the air supply line interconnecting the air intake filter and the heat exchanger and a part of the air supply line interconnecting the heat exchanger and the air compressor and a bypass valve mounted in the second bypass line and configured to be controlled to be opened or closed by a controller.

In an embodiment, the controller may be configured to control the bypass valve to be opened when a fuel cell vehicle is in a high-load operating state.

In an embodiment, when water condensed in the heat exchanger is stored in the water tank, the controller may control the bypass valve to be opened upon determining that the amount of water stored in the water tank has reached a maximum level based on a signal from a water level sensor of the water tank.

Features and embodiments of the disclosure are discussed below.

### BRIEF DESCRIPTION OF THE DRAWINGS

The above and other features of embodiments of the present disclosure will now be described in detail with reference to certain exemplary embodiments illustrated in the accompanying drawings which are given hereinbelow by way of illustration only, and thus are not necessarily limitative of the present disclosure, and wherein:

FIG. 1 is a configuration diagram showing an air supply system and a heat/water management system of a conventional fuel cell system;

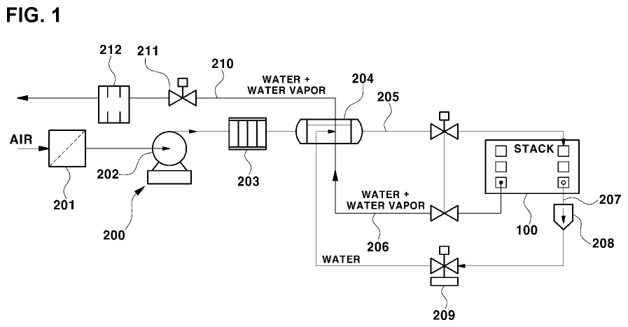

FIG. 2 is a configuration diagram showing a fuel cell system according to an embodiment of the present disclosure;

FIG. 3 is a configuration diagram showing a fuel cell system according to an embodiment of the present disclosure;

FIG. 4 is a cross-sectional view of a heat exchanger among components of a fuel cell system according to an embodiment of the present disclosure;

FIG. 5 is a cross-sectional view of a heat exchanger among components of a fuel cell system according to an embodiment of the present disclosure;

FIG. 6 is a cross-sectional view of a vortex cooler among components of a fuel cell system according to an embodiment of the present disclosure; and

FIG. 7 is a flowchart showing an example of a control process for collection of water of a fuel cell system according to an embodiment of the present disclosure.

It should be understood that the appended drawings are not necessarily drawn to scale, presenting a somewhat simplified representation of various features illustrative of basic principles of embodiments of the disclosure. Specific design features of an embodiment of the present disclosure as disclosed herein, including, for example, specific dimensions, orientations, locations, and shapes, can be determined in part by the particular intended application and use environment. In the figures, reference numbers refer to the same or equivalent parts of embodiments of the present disclosure throughout the drawings.

### DETAILED DESCRIPTION OF ILLUSTRATIVE EMBODIMENTS

Various exemplary embodiments will now be described more fully with reference to the accompanying drawings, in which only some exemplary embodiments are shown. Specific structural and functional details disclosed herein can be merely representative for the purpose of describing exemplary embodiments. The present disclosure, however, may be embodied in many alternate forms, and should not be construed as being necessarily limited only to the exemplary embodiments set forth herein. Accordingly, while exemplary embodiments of the disclosure are capable of being variously modified and taking alternative forms, embodiments thereof are shown by way of example in the drawings and will herein be described in detail. It should be understood, however, that there is no intent to necessarily limit the present disclosure to the particular exemplary embodiments disclosed. On the contrary, an embodiment can cover all modifications, equivalents, and alternatives falling within the scope of the disclosure.

It will be understood that, although the terms “first”, “second”, etc. may be used herein to describe various elements, these elements should necessarily not be limited by these terms. These terms can be merely used to distinguish one element from another. For example, a first element can be termed a second element, and, similarly, a second element can be termed a first element, without departing from the scope of embodiments of the present disclosure.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements can be interpreted in a like fashion (e.g. “between” versus “directly between”, “adjacent” versus “directly adjacent”, etc.).

Wherever possible, the same reference numbers will be used throughout the drawings to refer to the same or like parts. The terminology used herein is for the purpose of describing particular embodiments only and is not intended to be necessarily limiting of potential embodiments of the disclosure. As used herein, the singular forms “a”, “an”, and “the” can include the plural forms as well, unless the context clearly indicates otherwise. It will be further understood that the terms “comprises”, “comprising”, “includes”, and/or “including”, when used herein, specify the presence of stated components, steps, operations, and/or elements, but do not preclude the presence or addition of one or more other components, steps, operations, and/or elements.

Hereinafter, exemplary embodiments of the present disclosure will be described in detail with reference to the accompanying drawings.

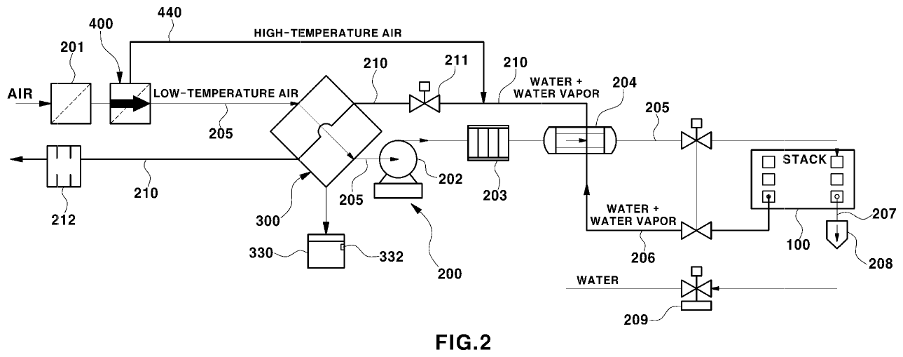

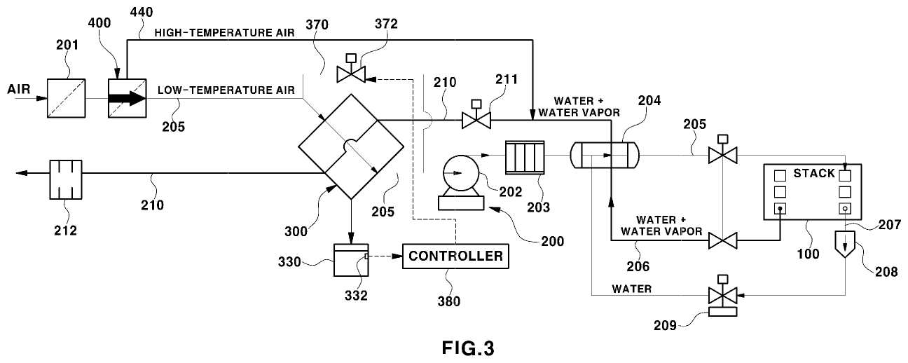

FIGS. 2 and 3 are diagrams showing configurations of fuel cell systems according to embodiments of the present disclosure.

As shown in FIGS. 2 and 3, an air supply system 200 for supplying air to a stack 100 may include an air intake filter 201 configured to remove foreign substances contained in outside air, an air compressor 202 configured to suction and compress outside air and to supply the compressed air to a humidifier 204, and an air intake cooler 203 configured to cool the compressed air before the compressed air enters the humidifier 204, wherein the humidifier 204 humidifies the air from the air intake cooler 203 so that the air has an appropriate humidity, and then supplies the humidified air to an air electrode of the stack 100.

In detail, the air intake filter 201, the air compressor 202, the air intake cooler 203, and the humidifier 204 may be sequentially arranged in an air flow direction in an air supply line 205 connected to the air electrode of the stack 100.

As the stack 100 of an embodiment operates, exhaust gas (wet gas state containing water and water vapor) discharged from the air electrode of the stack passes through a wet air line 206, and flows along an outer peripheral portion of a hollow fiber membrane in the humidifier 204. Only portions of the water and the water vapor contained in the exhaust gas enter the hollow fiber membrane due to a capillary phenomenon and humidify dry air, and remaining portions of the water and the water vapor contained in the exhaust gas can be discharged to the outside along a wet air discharge line 210 connected to the humidifier 204.

In an embodiment, an air pressure regulator 211 configured to regulate discharge pressure of the exhaust gas and a silencer 212 configured to regulate noise of the exhaust gas may be sequentially connected along the wet air discharge line 210.

An embodiment of the present disclosure can collect as much water as possible from the high-temperature and high-humidity exhaust gas (wet gas state containing water and water vapor) discharged from the stack, i.e. the high-temperature and high-humidity exhaust gas (wet gas state containing water and water vapor) discharged to the outside along the wet air discharge line 210 connected to the humidifier 204, so that the water is recycled.

A heat exchanger 300 can be configured to perform heat exchange between low-temperature air flowing toward the stack along the air supply line 205 and the high-temperature and high-humidity exhaust gas flowing to the outside along the wet air discharge line 210. As shown in FIGS. 2 and 3, the heat exchanger 300 can be mounted at a designed, preset, or selected position so as to be connected both to the air supply line 205 and to the wet air discharge line 210.

Preferably, the heat exchanger 300 may be mounted at a position at which a part of the air supply line 205 that interconnects the air intake filter 201 and the air compressor 202 and a part of the wet air discharge line 210 that extends from the humidifier 204 to interconnect the air pressure regulator 211 and the silencer 212 intersect each other.

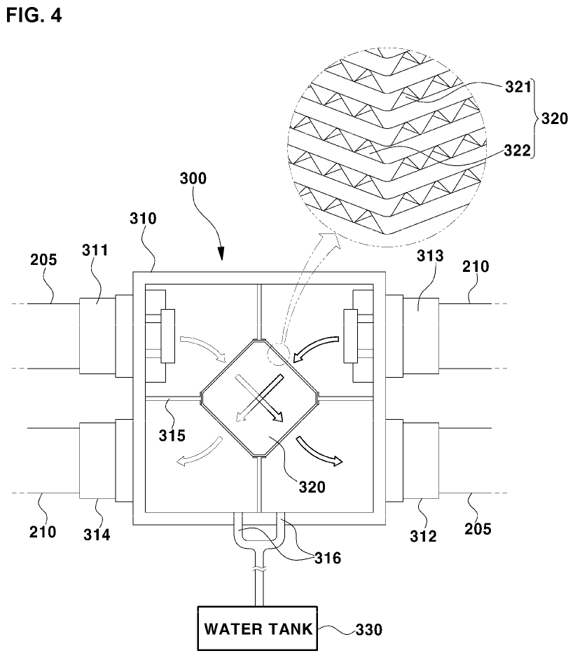

As shown in FIG. 4, a heat exchanger 300 according to an embodiment of the present disclosure may include a case 310, which is mounted at a position at which the air supply line 205 and the wet air discharge line 210 intersect each other. And, a heat exchanger 300 according to an embodiment may include a heat exchange member 320, which is mounted in the case 310 to substantially perform heat exchange between the air flowing along the air supply line 205 and the high-temperature and high-humidity exhaust gas flowing along the wet air discharge line 210.

As can be readily seen in FIG. 4, the case 310 of the heat exchanger 300 can include an air supply port 311 and an exhaust gas outlet port 314, which are formed on one side of the case 310. And, the case 310 of the heat exchanger 300 can include an exhaust gas inlet port 313 and an air discharge port 312, which are formed on the opposite side of the case 310. A part of the air supply line 205 that extends from the air intake filter 201 can be connected to the air supply port 311. A part of the wet air discharge line 210 that extends to the silencer 212 can be connected to the exhaust gas outlet port 314. A part of the wet air discharge line 210 that extends from the humidifier 204 and passes through the air pressure regulator 211 can be connected to the exhaust gas inlet port 313. And, a part of the air supply line 205 that extends to the air compressor 202 can be connected to the air discharge port 312.

As can be readily seen in the enlarged portion in FIG. 4, in an embodiment, the heat exchange member 320 of the heat exchanger 300 may be structured such that a plurality of first heat exchange passages 321, through which air flows from the air supply port 311 to the air discharge port 312, and a plurality of second heat exchange passages 322, through which exhaust gas flows from the exhaust gas inlet port 313 to the exhaust gas outlet port 314, are formed so as to cross each other.

In more detail, the heat exchange member 320 of an embodiment may be structured such that plates that can be made of pulp and bent multiple times in a zigzag pattern in one direction in order to form the plurality of first heat exchange passages 321 and plates that can be made of pulp and bent multiple times in a zigzag pattern in a perpendicular direction in order to form the plurality of second heat exchange passages 322 are alternately stacked in a vertical direction.

In an embodiment, diaphragms 315 may be connected between four corners of the heat exchange member 320 and four inner surfaces of the case 310 so that air introduced into the case 310 from the air supply port 311 is guided to move to the air discharge port 312 along the first heat exchange passages 321, and high-temperature and high-humidity exhaust gas introduced into the case 310 from the exhaust gas inlet port 313 is guided to move to the exhaust gas outlet port 314 along the second heat exchange passages 322.

In addition, the case 310 of an embodiment can include drain holes 316 formed in the lower portion thereof in order to collect condensed water generated from the exhaust gas during heat exchange between the air flowing through the first heat exchange passages 321 and the exhaust gas flowing through the second heat exchange passages 322, and a water tank 330 configured to store the condensed water is connected to the drain holes 316 formed in the case 310.

Next, a heat exchange process of the heat exchanger according to an embodiment of the present disclosure will be described while referring to FIGS. 2-4.

Low-temperature air to be supplied to the stack 100 is filtered by the air intake filter 201 and then flows to the air supply port 311 of the case 310 along the air supply line 205. High-temperature and high-humidity exhaust gas (wet gas state containing water and water vapor) discharged from the stack 100 and having passed through the humidifier 204 flows to the exhaust gas inlet port 313 of the case 310 along the wet air discharge line 210.

Subsequently, the low-temperature air having passed through the air supply port 311 of the case 310 flows along the first heat exchange passages 321 of the heat exchange member 320, and at the same time, the high-temperature and high-humidity exhaust gas having passed through the exhaust gas inlet port 313 of the case 310 flows along the second heat exchange passages 322 of the heat exchange member 320.

While crossing paths, the low-temperature air flowing along the first heat exchange passages 321 of the heat exchange member 320 and the high-temperature and high-humidity exhaust gas flowing along the second heat exchange passages 322 of the heat exchange member 320 exchange heat with each other, whereby condensed water may be generated from the high-temperature and high-humidity exhaust gas.

Referring to FIG. 4, condensed water generated from the exhaust gas during heat exchange between the air flowing through the first heat exchange passages 321 and the high-temperature and high-humidity exhaust gas flowing through the second heat exchange passages 322 may be stored in the water tank 330 through the drain holes 316 formed in the lower portion of the case 310.

In an embodiment, water collected and stored in the water tank 330 by heat exchange between the air flowing through the first heat exchange passages 321 and the high-temperature and high-humidity exhaust gas flowing through the second heat exchange passages 322 may be recycled as sprinkling water for cooling of a radiator, handwashing, or dust removal, or as camping water. In addition, in an embodiment, it is possible to minimize the amount of water that is uselessly discharged out of a fuel cell vehicle, thereby preventing accidents attributable to freezing of the discharged water on roads or parking lots, or accidents attributable to splash of the discharged water onto a following vehicle during high-speed travel.

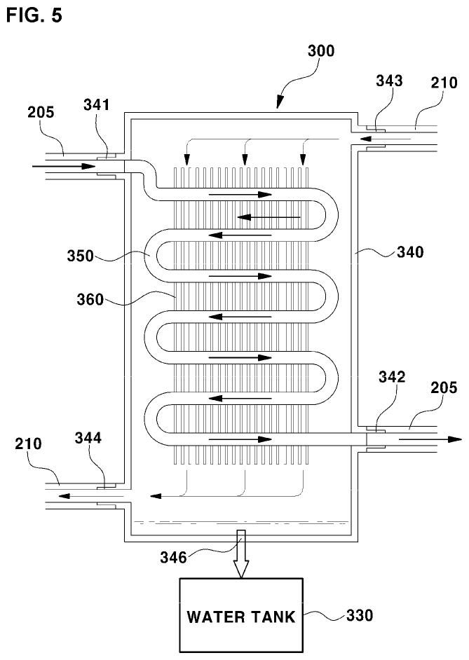

As shown in FIG. 5, the heat exchanger 300 according to an embodiment of the present disclosure may include a housing 340, which is mounted at a position at which the air supply line 205 and the wet air discharge line 210 intersect each other, an air flow pipe 350, which is formed in a zigzag shape and is located in the housing 340 so as to be connected between an air supply port 341 of the housing 340 and an air discharge port 342 of the housing 340, and a plurality of heat exchange fins 360, which are attached to the surface of the air flow pipe 350.

As can be readily seen in FIG. 5, the housing 340 of the heat exchanger 300 includes an air supply port 341 and an exhaust gas outlet port 344, which are formed on one side of the housing 340, and includes an exhaust gas inlet port 343 and an air discharge port 342, which are formed on the opposite side of the housing 340. A part of the air supply line 205 that extends from the air intake filter 201 can be connected to the air supply port 341. A part of the wet air discharge line 210 that extends to the silencer 212 can be connected to the exhaust gas outlet port 344. A part of the wet air discharge line 210 that extends from the humidifier 204 and passes through the air pressure regulator 211 can be connected to the exhaust gas inlet port 343. And, a part of the air supply line 205 that extends to the air compressor 202 can be connected to the air discharge port 342.

Therefore, in an embodiment, high-temperature and high-humidity exhaust gas (wet gas state containing water and water vapor) can be introduced into the housing 340 through the exhaust gas inlet port 343, and can flow to the exhaust gas outlet port 344. To cross paths in the housing 340, low-temperature air can be introduced into the air flow pipe 350 through the air supply port 341, and can flow to the air discharge port 342. The high-temperature and high-humidity exhaust gas comes into contact with the surface of the air flow pipe 350 and the surfaces of the heat exchange fins 360, thereby exchanging heat with the low-temperature air.

In addition, the housing 340 of an embodiment can include a drain hole 346 formed in the lower portion thereof to collect condensed water generated from the high-temperature and high-humidity exhaust gas by the above-described heat exchange, and a water tank 330 configured to store the condensed water can be connected to the drain hole 346.

Next, a heat exchange process of the heat exchanger according to an embodiment of the present disclosure will be described while referring to FIGS. 2, 3, and 5.

Low-temperature air to be supplied to the stack 100 is filtered by the air intake filter 201 and then flows to the air supply port 341 of the housing 340 along the air supply line 205. The high-temperature and high-humidity exhaust gas (wet gas state containing water and water vapor) discharged from the stack 100 and having passed through the humidifier 204 flows to the exhaust gas inlet port 343 of the housing 340 along the wet air discharge line 210.

Subsequently, the low-temperature air having passed through the air supply port 341 of the housing 340 flows through the air flow pipe 350, and high-temperature and high-humidity exhaust air having passed through the exhaust gas inlet port 343 of the housing 340 flows to the exhaust gas outlet port 344 through the inner space in the housing 340.

While crossing paths inside the housing 340, the low-temperature air flowing through the air flow pipe 350 and the high-temperature and high-humidity exhaust gas flowing through the inner space in the housing 340 exchange heat with each other, whereby condensed water may be generated from the high-temperature and high-humidity exhaust gas.

That is, the high-temperature and high-humidity exhaust gas flowing through the inner space in the housing 340 comes into contact with the surface of the air flow pipe 350, through which the low-temperature air flows, and the surfaces of the heat exchange fins 360, and exchanges heat with the low-temperature air flowing through the air flow pipe 350, whereby condensed water may be generated from the high-temperature and high-humidity exhaust gas.

The condensed water generated from the exhaust gas during heat exchange between the low-temperature air flowing through the air flow pipe 350 and the high-temperature and high-humidity exhaust gas flowing through the inner space in the housing 340 may be stored in the water tank 330 through the drain hole 346 formed in the lower portion of the housing 340. The water stored in the water tank 330 may be recycled as sprinkling water for cooling of a radiator, handwashing, or dust removal, or as camping water. In addition, in an embodiment, it is possible to minimize the amount of water that is uselessly discharged out of a fuel cell vehicle, thereby preventing accidents attributable to freezing of the discharged water on roads or parking lots, or accidents attributable to splash of the discharged water onto a following vehicle during high-speed travel.

Referring to FIGS. 2, 3, and 6, in an embodiment, a vortex cooler 400 may be further mounted in a part of the air supply line 205 that interconnects the air intake filter 201 and the heat exchanger 300.

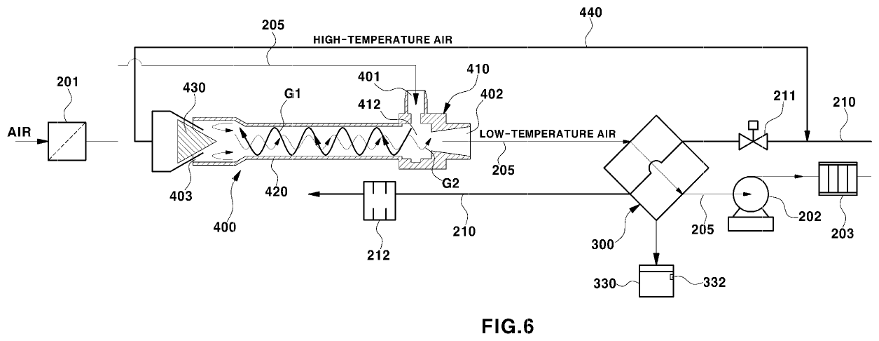

In an embodiment, as illustrated in FIG. 6, the vortex cooler 400 may have a structure for dividing the air having passed through the air intake filter 201 into cold air and hot air, supplying the cold air to the heat exchanger 300, and supplying the hot air to a part of the wet air discharge line 210 that interconnects the humidifier 204 and the air pressure regulator 211.

In addition, in an embodiment, a first bypass line 440, through which the hot air created in the vortex cooler 400 flows to the wet air discharge line 210, can be connected between a high-temperature gas discharge port 403 of the vortex cooler 400 and a part of the wet air discharge line 210 that is located between the humidifier 204 and the air pressure regulator 211.

In an embodiment, the vortex cooler 400 can be a vortex tube that divides a vortex gas rotating at a high speed into a high-temperature gas and a low-temperature gas using a spontaneous energy separation phenomenon. As illustrated in FIG. 6, the vortex cooler 400 of an embodiment may include a main body 410 having a vortex generation chamber 412, a vortex circulation tube 420 connected to the main body 410 so as to communicate with the vortex generation chamber 412, and a regulation valve 430 mounted to a distal end portion of the vortex circulation tube 420 to regulate the size of the high-temperature gas discharge port 403.

In addition, in an embodiment, an air supply port 401 can be formed in an upper portion of the main body 410 to supply air to the vortex generation chamber 412. A low-temperature gas discharge port 402 can be formed in an end portion of the main body 410. The high-temperature gas discharge port 403 can be formed in the distal end portion of the vortex circulation tube 420.

In an embodiment, a part of the air supply line 205 that extends from the air intake filter 201 can be connected to the air supply port 401, a part of the air supply line 205 that extends to the heat exchanger 300 can be connected to the low-temperature gas discharge port 402, and the first bypass line 440 can be connected to the high-temperature gas discharge port 403.

In an embodiment, the air filtered by the air intake filter 201 can be supplied to the vortex generation chamber 412 through the air supply port 401 of the vortex cooler 400, and can be perpendicularly sprayed to the vortex circulation tube 420 while contacting the wall surface of the vortex generation chamber 412. Subsequently, the air sprayed to the vortex circulation tube 420 has spiral rotating energy, like a whirlwind, and thus moves to the high-temperature gas to discharge port 403 formed in the distal end portion of the vortex circulation tube 420.

In addition, in an embodiment, the spiral rotating energy of the air, which spirally rotates and moves to the distal end portion of the vortex circulation tube 420, can be changed to thermal energy due to loss of viscosity, whereby the temperature of the air gradually rises to high temperature.

When the regulation valve 430 mounted to the distal end portion of the vortex circulation tube 420 is in a state of being opened to a predetermined, preset, or selected degree, a portion of the high-temperature air, which has been increased in temperature by the changed thermal energy, may be discharged through the high-temperature gas discharge port 403, and then may be supplied to a part of the wet air discharge line 210 that is located between the humidifier 204 and the air pressure regulator 211 through the first bypass line 440. Accordingly, the temperature of the high-temperature and high-humidity exhaust gas flowing through the wet air discharge line 210 may further rise.

Simultaneously, the remaining portion of the high-temperature air, not discharged through the high-temperature gas discharge port 403, is reversed in direction, and flows back to a side opposite the distal end portion while spirally rotating about the central portion of the vortex circulation tube 420.

In an embodiment, the high-temperature air flowing back while spirally rotating about the central portion of the vortex circulation tube 420 (denoted by G2 in FIG. 6) and the air moving toward the distal end portion of the vortex circulation tube 420 while spirally rotating (denoted by G1 in FIG. 6) are at about the same temperature. However, the spiral rotating speed of the high-temperature air G2 flowing back while spirally rotating about the central portion of the vortex circulation tube 420 is less than that of the air G1, and thus the total enthalpy of the high-temperature air G2 is less than that of the air G1 moving toward the distal end portion of the vortex circulation tube 420 while spirally rotating.

Accordingly, the high-temperature air G2 flowing back while spirally rotating about the central portion of the vortex circulation tube 420 may gradually lose heat and may be cooled, and thus may be changed to low-temperature air. This low-temperature air may be directly supplied to the heat exchanger 300 through the low-temperature gas discharge port 406.

In this way, the low-temperature air generated in the vortex cooler 400 can be supplied to the heat exchanger 300, and at the same time, the high-temperature air generated in the vortex cooler 400 can be supplied to a part of the wet air discharge line 210 that is located between the humidifier 204 and the air pressure regulator 211 through the first bypass line 440. Accordingly, the high-temperature and high-humidity exhaust gas moving toward the heat exchanger 300 through the wet air discharge line 210 may be increased in temperature. As a result, in an embodiment, it is possible to maximize or increase the amount of water that is collected from the condensed water generated from the high-temperature and high-humidity exhaust gas through the above-described heat exchange process of the heat exchanger 300.

In detail, in an embodiment, a difference between the temperature of the air to be supplied to the stack 100 and the temperature of the exhaust gas discharged from the wet air discharge line 210 is not greater than a preset, selected, or predetermined level, and thus the amount of water that is collected from the condensed water obtained from the exhaust gas through heat exchange may be small. However, because the air to be supplied to the stack can be cooled by the vortex cooler 400 in an embodiment, and the exhaust gas discharged from the stack can be heated by the vortex cooler 400, the difference between the temperature of the air to be supplied to the stack 100 and the temperature of the exhaust gas discharged from the stack 100 may exceed the preset, selected, or predetermined level.

Accordingly, in an embodiment, the low-temperature air generated in the vortex cooler 400 can be supplied to the heat exchanger 300, and at the same time, the exhaust gas that is increased in temperature by the high-temperature air generated in the vortex cooler 400 can be supplied to the heat exchanger 300, whereby it is possible to further maximize or increase the amount of water that is collected from the condensed water generated from the high-temperature and high-humidity exhaust gas through the heat exchange process of the heat exchanger 300.

In addition, in an embodiment as illustrated in FIG. 3, a second bypass line 370 can be connected between a part of the air supply line 205 that interconnects the air intake filter 201 and the heat exchanger 300 and a part of the air supply line 205 that interconnects the heat exchanger 300 and the air compressor 202, and a bypass valve 372 can be mounted in the second bypass line 370. In an embodiment, the bypass valve 372 can be controlled to be opened or closed by the controller 380 (see, e.g., FIG. 3).

The controller 380 may be configured to control the bypass valve 372 to be opened when a fuel cell vehicle is in a high-load operating state. In addition, in an embodiment, when the water condensed in the heat exchanger 300 is stored in the water tank 330, the controller 380 may control the bypass valve 372 to be opened upon determining that the amount of water stored in the water tank 330 has reached a maximum level based on a signal from a water level sensor 332 of the water tank 330 (see FIG. 3).

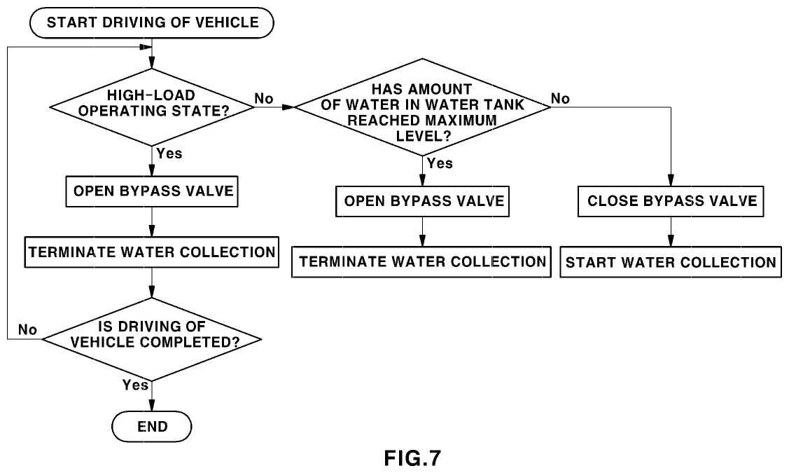

When a fuel cell vehicle is in a high-load operating state in which high or maximum output is required, it can be more important to produce the maximum output than to collect water. As shown in FIG. 7, the controller 380 of an embodiment can perform a process of determining whether the fuel cell vehicle is in a high-load operating state and a process of controlling the bypass valve 372 mounted in the second bypass line 370 to be opened upon determining that the fuel cell vehicle is in a high-load operating state, thereby terminating the water collection process.

Accordingly, in an embodiment, the air filtered by the air intake filter 201 may not flow to the heat exchanger 300, but may pass through the second bypass line 370 having a low pressure, and may then be supplied to the air compressor 202 to be compressed. The air compressed by the air compressor 202 may sequentially pass through the air intake cooler 203 and the humidifier 204, and may then be supplied to the air electrode of the stack 100.

Alternatively, as shown in FIG. 7, the controller 380 of an embodiment can perform a process of determining whether the amount of water stored in the water tank 330 has reached a maximum level or a threshold level based on a signal from the water level sensor 332 (see, e.g., FIG. 3) sensing the water level in the water tank 330 and a process of controlling the bypass valve 372 mounted in the second bypass line 370 to be opened upon determining that the amount of water stored in the water tank 330 has reached the maximum/threshold level, thereby terminating the water collection process.

As is apparent from the above description, an embodiment of the present disclosure can have the following effects and advantages.

First, heat exchange between high-temperature and high-humidity exhaust gas (wet gas state containing water and water vapor) discharged from the stack and inlet air to be supplied to the stack can be performed by a heat exchanger. Therefore, in an embodiment, it is possible to easily collect condensed water generated from the high-temperature and high-humidity exhaust gas discharged from the stack and to store the collected water. The stored water may be recycled as sprinkling water for cooling of a radiator, handwashing, or dust removal, or as camping water, for example.

Second, inlet air to be supplied to the stack can be divided into low-temperature cold air and high-temperature hot air by a vortex cooler. In an embodiment, the low-temperature cold air can be supplied to the heat exchanger, and at the same time, the high-temperature hot air can be supplied to a wet air discharge line, through which the high-temperature and high-humidity exhaust gas flows toward the heat exchanger, whereby the high-temperature and high-humidity exhaust gas can be increased in temperature. Accordingly, the high-temperature and high-humidity exhaust gas can be more easily condensed in the heat exchanger. As a result, in an embodiment, it is possible to further maximize or increase the amount of water that is collected from the condensed water generated from the high-temperature and high-humidity exhaust gas.

Third, because water can be collected from the exhaust gas discharged from the stack, in an embodiment, it is possible to minimize or reduce the amount of water that is uselessly discharged out of a fuel cell vehicle, thereby preventing accidents attributable to freezing of the discharged water on roads or parking lots, or accidents attributable to splash of the discharged water onto a following vehicle during high-speed travel, for example.

Embodiments of the present disclosure has been described above with reference to an exemplary drawings. The embodiments described in the specification and shown in the accompanying drawings are illustrative only and are not necessarily intended to represent all options and combinations of the disclosure. Therefore, the present disclosure is not necessarily limited to the embodiments presented herein, and it is to be understood by those skilled in the art that various modifications or changes can be made without departing from the technical spirit or scope of the disclosure as disclosed in the appended claims.

What is claimed is:

1. A fuel cell system comprising:
a stack;
an air supply line coupled to the stack to supply air to the stack;
a wet air discharge line coupled to the stack to discharge relatively-higher-temperature and relatively-higher-humidity exhaust gas; and
a heat exchanger mounted at a position so as to be coupled to the air supply line and the wet air discharge line, the heat exchanger being configured to perform heat exchange between relatively-lower-temperature air flowing along the air supply line and the relatively-higher-temperature and relatively-higher-humidity exhaust gas flowing along the wet air discharge line.

2. The system of claim 1, wherein the heat exchanger is mounted at an intersection point between a part of the air supply line interconnecting an air intake filter and an air compressor, and a part of the wet air discharge line extending from a humidifier and interconnecting an air pressure regulator and a silencer.

3. The system of claim 2, wherein the heat exchanger comprises:
a case comprising an air supply port and an exhaust gas outlet port formed on a first side of the case, and the case comprising an exhaust gas inlet port and an air discharge port formed on a second side of the case,
wherein a part of the air supply line extending from the air intake filter is coupled to the air supply port,
wherein a part of the wet air discharge line extending to the silencer is coupled to the exhaust gas outlet port,
wherein a part of the wet air discharge line extending from the humidifier and passing through the air pressure regulator is coupled to the exhaust gas inlet port, and
wherein a part of the air supply line extending to the air compressor is coupled to the air discharge port; and
a heat exchange member mounted in the case, the heat exchange member comprising a plurality of first heat exchange passages formed to allow air to flow from the air supply port to the air discharge port therethrough, and the heat exchange member comprising a plurality of second heat exchange passages formed to allow exhaust gas to flow from the exhaust gas inlet port to the exhaust gas outlet port therethrough,
wherein the plurality of first heat exchange passages and the plurality of second heat exchange passages cross each other.

4. The system of claim 3, wherein the case further comprises a drain hole formed in a lower portion of the case.

5. The system of claim 4, further comprising a water tank coupled to the drain hole.

6. The system of claim 2, wherein the heat exchanger comprises:
a housing comprising an air supply port and an exhaust gas outlet port formed on a first side of the housing, and the housing comprising an exhaust gas inlet port and an air discharge port formed on a second side of the housing,
wherein a part of the air supply line extending from the air intake filter is coupled to the air supply port,
wherein a part of the wet air discharge line extending to the silencer is coupled to the exhaust gas outlet port,
wherein a part of the wet air discharge line extending from the humidifier and passing through the air pressure regulator is coupled to the exhaust gas inlet port, and
wherein a part of the air supply line extending to the air compressor is coupled to the air discharge port;
an air flow pipe formed in a zigzag shape and located in the housing so as to be coupled between the air supply port and the air discharge port; and
heat exchange fins attached to the air flow pipe, such that during operation, exhaust gas introduced into the housing through the exhaust gas inlet port and flowing toward the exhaust gas outlet port, exchanges heat with air flowing through the air flow pipe through the heat exchange fins.

7. The system of claim 6, wherein the housing further comprises a drain hole formed in a lower portion of the housing.

8. The system of claim 7, further comprising a water tank coupled to the drain hole.

9. The system of claim 2, further comprising a vortex cooler mounted in a part of the air supply line interconnecting the air intake filter and the heat exchanger.

10. The system of claim 9, wherein the vortex cooler is configured to divide air to be supplied to the stack from the air intake filter into relatively-lower-temperature air and relatively-higher-temperature air,
wherein the vortex cooler is configured to supply the relatively-lower-temperature air to the heat exchanger, and
wherein the vortex cooler is configured to supply the relatively-higher-temperature air to a part of the wet air discharge line located between the humidifier and the air pressure regulator.

11. The system of claim 10, further comprising a first bypass line connected between a relatively-higher-temperature gas discharge port of the vortex cooler and a part of the wet air discharge line located between the humidifier and the air pressure regulator to allow the relatively-higher-temperature air to flow to the wet air discharge line.

12. The system of claim 2, further comprising:
a second bypass line connected between a part of the air supply line interconnecting the air intake filter and the heat exchanger and a part of the air supply line interconnecting the heat exchanger and the air compressor;
a bypass valve mounted at the second bypass line; and
a controller configured to control opening and closing of the bypass valve.

13. The system of claim 12, wherein the controller is configured to control the bypass valve to be opened when a fuel cell vehicle is in a relatively-higher-load operating state.

14. The system of claim 12, wherein the controller is configured to control the bypass valve to be opened upon determining that an amount of water stored in a water tank has reached a threshold level based on a signal from a water level sensor of the water tank.

15. A fuel cell system comprising:
a stack;
an air supply line coupled to the stack to supply air to the stack;
a wet air discharge line coupled to the stack to discharge relatively-higher-temperature and relatively-higher-humidity exhaust gas;
a heat exchanger mounted at a position so as to be coupled to the air supply line and the wet air discharge line,
wherein the heat exchanger is configured to perform heat exchange between relatively-lower-temperature air flowing along the air supply line and the relatively-higher-temperature and relatively-higher-humidity exhaust gas flowing along the wet air discharge line,
wherein the heat exchanger is mounted at an intersection point between a part of the air supply line interconnecting an air intake filter and an air compressor, and a part of the wet air discharge line extending from a humidifier and interconnecting an air pressure regulator and a silencer; and
a vortex cooler mounted in a part of the air supply line interconnecting the air intake filter and the heat exchanger.

16. The system of claim 15, further comprising:
a first bypass line connected between a relatively-higher-temperature gas discharge port of the vortex cooler and a part of the wet air discharge line located between the humidifier and the air pressure regulator to allow the relatively-higher-temperature air to flow to the wet air discharge line;
a second bypass line connected between a part of the air supply line interconnecting the air intake filter and the heat exchanger and a part of the air supply line interconnecting the heat exchanger and the air compressor;
a bypass valve mounted at the second bypass line; and
a controller configured to control opening and closing of the bypass valve,
wherein the controller is configured to control the bypass valve to be opened when a fuel cell vehicle is in a relatively-higher-load operating state, and
wherein the controller is configured to control the bypass valve to be opened upon determining that an amount of water stored in a water tank has reached a threshold level based on a signal from a water level sensor of the water tank.

17. A fuel cell system comprising:
a stack;
an air supply line coupled to the stack to supply air to the stack;
a wet air discharge line coupled to the stack to discharge relatively-higher-temperature and relatively-higher-humidity exhaust gas;
a heat exchanger mounted at a position so as to be coupled to the air supply line and the wet air discharge line,
wherein the heat exchanger is configured to perform heat exchange between relatively-lower-temperature air flowing along the air supply line and the relatively-higher-temperature and relatively-higher-humidity exhaust gas flowing along the wet air discharge line,
wherein the heat exchanger is mounted at an intersection point between a part of the air supply line interconnecting an air intake filter and an air compressor, and a part of the wet air discharge line extending from a humidifier and interconnecting an air pressure regulator and a silencer,
wherein the heat exchanger comprises:
a case comprising an air supply port and an exhaust gas outlet port formed on a first side of the case, and the case comprising an exhaust gas inlet port and an air discharge port formed on a second side of the case,
wherein a part of the air supply line extending from the air intake filter is coupled to the air supply port,
wherein a part of the wet air discharge line extending to the silencer is coupled to the exhaust gas outlet port,
wherein a part of the wet air discharge line extending from the humidifier and passing through the air pressure regulator is coupled to the exhaust gas inlet port, and
wherein a part of the air supply line extending to the air compressor is coupled to the air discharge port,
wherein the case further comprises a drain hole formed in a lower portion of the case, and
a heat exchange member mounted in the case, the heat exchange member comprising a plurality of first heat exchange passages formed to allow air to flow from the air supply port to the air discharge port therethrough, and the heat exchange member comprising a plurality of second heat exchange passages formed to allow exhaust gas to flow from the exhaust gas inlet port to the exhaust gas outlet port therethrough, wherein the plurality of first heat exchange passages and the plurality of second heat exchange passages cross each other; and
a water tank coupled to the drain hole of the case of the heat exchanger.

17. The system of claim 15,
wherein the vortex cooler is configured to divide air to be supplied to the stack from the air intake filter into relatively-lower-temperature air and relatively-higher-temperature air,
wherein the vortex cooler is configured to supply the relatively-lower-temperature air to the heat exchanger, and
wherein the vortex cooler is configured to supply the relatively-higher-temperature air to a part of the wet air discharge line located between the humidifier and the air pressure regulator.

18. The system of claim 15, further comprising:
a first bypass line connected between a relatively-higher-temperature gas discharge port of the vortex cooler and a part of the wet air discharge line located between the humidifier and the air pressure regulator to allow the relatively-higher-temperature air to flow to the wet air discharge line;
a second bypass line connected between a part of the air supply line interconnecting the air intake filter and the heat exchanger and a part of the air supply line interconnecting the heat exchanger and the air compressor; and
a bypass valve mounted at the second bypass line.

19. The system of claim 18, further comprising a controller configured to control opening and closing of the bypass valve,
wherein the controller is configured to control the bypass valve to be opened when a fuel cell vehicle is in a relatively-higher-load operating state, and
wherein the controller is configured to control the bypass valve to be opened upon determining that an amount of water stored in a water tank has reached a threshold level based on a signal from a water level sensor of the water tank.
